(19) United States
(12) Patent Application Publication
(10) Pub. No.: US 2003/0046538 A1
(43) Pub. Date: Mar. 6, 2003

(54) Method for subscription between a terminal and a base station in a telecommunication system

(76) Inventor: Pierre Hugues Boucher, Saint-Avertin (FR)

Correspondence Address: U.S. Philips Corporation, 580 White Plains Road, Tarrytown, NY, 10591, US

(21) Appl. No.: 10/206,312

(22) Filed: Jul. 24, 2002

(30) Foreign Application Priority Data
Jul. 31, 2001 (FR) 0110248

(51) Int. Cl. H04L 9/00

(52) U.S. Cl. 713/161

(57) ABSTRACT

The invention concerns a method for the subscription of a terminal to a base station in a telecommunications system. The method involves the use of a call control entity for communicating the appropriate information between the terminal and the base station with a view to a subscription, without the use of the management mobility procedure provided for by the DECT standard.

Application: telecommunication systems, mobile telephony.

The invention relates to a transmitter, a receiver and a subscription method for allowing access of a terminal to a base station in a telecommunications system.

The invention also relates to a computer program for implementing said method and a signal for conveying said computer program.

The invention has many applications, in particular in wireless transmission systems.

The standardization document published by the ETSI under number ETS 300 175-5 describes a procedure for subscription between a portable telephone receiver and a base station, called Mobility Management or MM. A subscription procedure is essential in a system including several terminals or more generally several transmitters and/or several receivers, for controlling the access of the various devices to the system and enabling them to communicate with each other.

One object of the invention is to provide more simple means to be used for implementing a subscription between a terminal and a base station.

For this purpose, a method is provided of subscribing a terminal to a base station, characterized in that it comprises the following steps:

a control step of authorizing the terminal to register with a base station,

a channel selection step of searching for a channel belonging to an authorized base station,

a first step of sending a message containing an identifier of said terminal to the selected base station,

a second step of sending messages containing predefined coded information,

a first step of receiving a message containing subscription acceptance information for informing the terminal that the subscription is authorized,

a storage step of storing an identifier corresponding to the identity of the base station,

a reinitialization step of reinitializing the terminal.

A method is also provided for authorizing the subscription of a terminal to a base station, comprising:

an initialization step of enabling the base station to go into subscription mode in order to authorize a base station to register with the base station,

a first reception step of receiving a message sent by the terminal and containing an identifier of the terminal,

a second reception step of receiving messages conveying coded information,

a verification step of verifying whether said coded information corresponds to an authorized terminal,

a sending step of sending a message conveying subscription acceptance information for informing the terminal that the subscription is authorized,

a storage step of storing said identifier of the terminal.

The invention will be further described with reference to examples of embodiment shown in the drawings to which, however, the invention is not restricted.

FIG. 1 is a diagram to illustrate a standard subscription procedure,

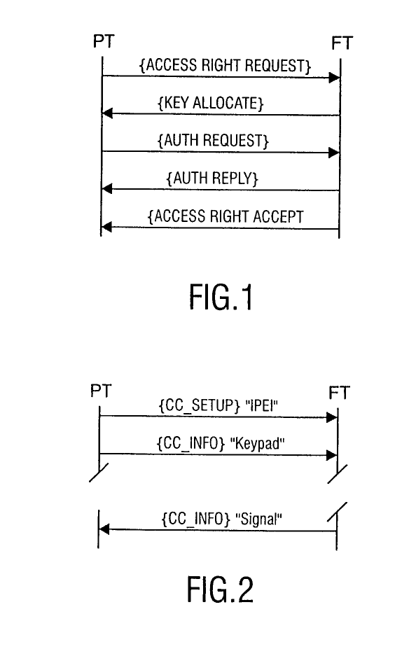

FIG. 2 is a diagram to illustrate an example of a subscription method according to the invention,

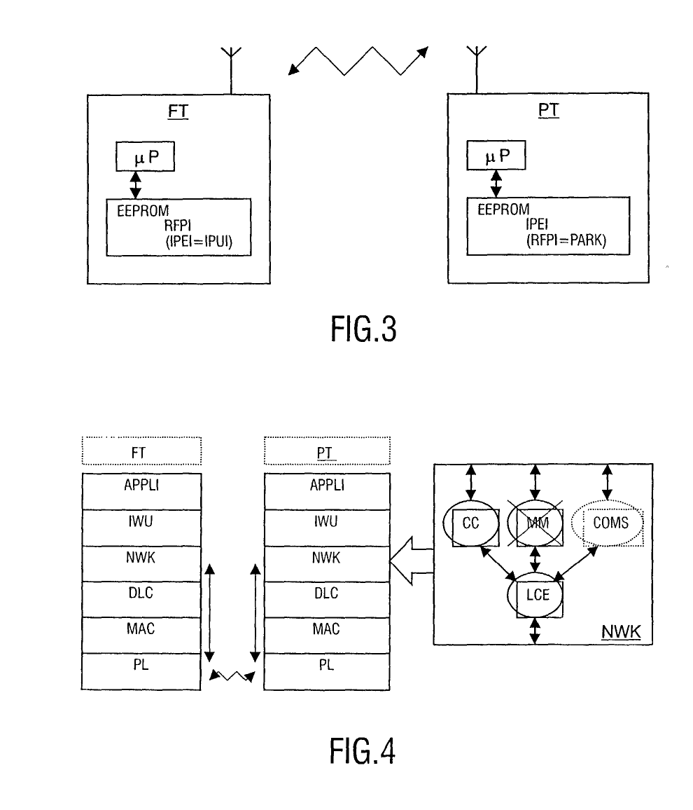

FIG. 3 is a functional block diagram to illustrate a hardware implementation of a telephone receiver and of a base station according to the invention,

FIG. 4 is a functional diagram to illustrate a software implementation of a telephone receiver and of a base station according to the invention.

FIG. 1 depicts, in a simplified manner, the main message exchanges performed during a standard subscription procedure between a terminal (PT) and a base station (FT) in a wireless telephone system of the DECT type (Digital Enhanced Cordless Telecommunications). According to this standard procedure described in paragraphs 5.6 and 13 in the aforementioned standardization document, the mobile terminal or PT makes a request for access {ACCESS RIGHT REQUEST} intended for the base station or FT. The FT sends back to it a key allocation {KEY ALLOCATE}. The PT responds with an authentication request {AUTH REQUEST}. Then the FT, depending on whether the authentication result is positive {AUTH REPLY} or negative {AUTH REJECT}, sends back to the PT a message {ACCESS RIGHT ACCEPT} indicating to it that the subscription request is accepted by the FT.

FIG. 2 shows, by way of an example of embodiment, the main message exchanges effected during a subscription method according to the invention for registering a terminal with a base station without using the standard procedure described briefly with reference to FIG. 1. According to this example of embodiment, the subscription method uses a standardized entity known as Call Control or CC, intended to effect the call control in circuit mode. This entity, as well as its functionalities, are described in paragraphs 5.2, 6.3.2 and 9 in the standardization document cited. Another entity can also be used in place of the CC. This may for example be the entity known as Connection Oriented Message Service or COMS intended to offer a point-to-point connection service for communications in packet mode. This service offers a faster and simpler call establishment than the CC entity. The COMS entity is described in the document cited, in paragraphs 5.4, 6.3.4 and 11.

In the example of embodiment depicted in FIG. 2, the method comprises the following steps.

An initialization step on the side of the FT enables the FT to go into subscription mode to authorize a terminal to register with it; for example, during the disconnection and connection of the FT to the supply network, the subscription mode is triggered on a rising edge of the supply.

A predefined control step on the side of the PT also puts the PT in subscription mode, for example using a predefined sequence of keys to be pressed on the terminal keypad.

A channel selection step is provided, during which the PT searches for a channel belonging to an FT in subscription mode.

When an FT in subscription mode is selected, an indication is sent to the PT to ask it what type of subscription is required; this step is useful in the case where several terminals can be registered with the same base station according to a predefined type of subscription.

The transaction can then start at the network layer of the two devices, for example by sending a message {CC_SETUP} from the PT to the FT containing the PT's identifier, the CC of the terminal requesting a service, referred to as service call in the standard, which conveys the identity information of the terminal, that is to say, its identifier or serial number or “IPEI”.

On reception of the message {CC_SETUP}, the FT goes into a standby mode to wait for a certain time until messages of the type {CC_INFO} conveying coded information “Keypad” are sent to it by the PT. The coded information awaited relates for example to numbers corresponding to key codes entered on the terminal keypad. These numbers, which are stored in the FT, enable the FT to detect and select the terminal as during the standard procedure using an authentication code of the AC type (Authentication Code), but without using the standard key allocation procedure.

When all the information is received, a check is made at the FT to verify that these codes correspond to an authorized terminal. Another message of the type {CC_INFO} conveying an item of information “Signal” is then sent to the PT in order to indicate to it whether or not the subscription request is accepted. If it is accepted, that is to say, the “keypad” code received is correct, the identifier of the terminal “IPEI” is stored in a memory of the FT, for example in an electrically erasable memory of the EEPROM type. For its part, the PT receives the message {CC_INFO} indicating to it whether its request is accepted. If such is the case, it stores the identifier of the FT “RFPI” which is broadcast continuously on the channel by the FT. If the code received by the FT is not correct, the FT sends rejection information to it and the PT resumes the procedure at the step of searching for a channel belonging to an FT in subscription mode.

When the subscription request is accepted, a reinitialization is necessary on each side in order to take account of the new parameters stored.

FIG. 3 describes an embodiment of a DECT telephone terminal (PT) and of a DECT base station (FT) according to the invention. Each apparatus, PT or FT, comprises a transmission/reception antenna for receiving radio signals, a microprocessor μP and a memory, for example of the EEPROM type, for storing the identity information of each apparatus. When it is stored in the PT, the identity information of the FT or RFPI becomes a portable access rights key or PARK allowing access to the base station. When it is stored in the FT, the identity information of the terminal or IPEI becomes an international portable identity number or IPUI.

FIG. 4 shows a software implementation of the invention. The FT and the PT are represented by software layers of the communication protocol used during the transmission. From top to bottom, there are:

an application layer APPLI which implements an interface between the user and the apparatus; this layer also manages algorithms in particular for connecting to the DECT network,

an interoperability layer IWU for managing calls and subscriptions,

a network layer NWK, the different components of which are detailed in FIG. 4; they comprise the following entities provided for in the standard cited:

a call control entity CC,

a mobility management entity MM,

an entity which supplies a point to point connection service for communications in packet mode COMS,

a router LCE, which recovers the messages from the bottom layer in order to direct them to the entity concerned,

an integrity layer DLC for ensuring the integrity of the messages received,

a layer managing the physical layer MAC,

and, finally, the physical layer consisting of the DECT radio part which communicates by radio with the physical layers of the other devices.

The invention does not use the standard mobility management entity MM for effecting subscriptions between a PT and an FT. It uses one of the other two entities CC or COMS.

1. A method for the subscription of a terminal to a base station, comprising:
a control step of authorizing the terminal to register with a base station,
a channel selection step of searching for a channel belonging to an authorized base station,
a first step of sending a message containing an identifier of said terminal to the selected base station,
a second step of sending messages containing predefined coded information,
a first step of receiving a message containing subscription acceptance information for informing the terminal that the subscription is authorized,
a storage step of storing an identifier corresponding to the identity of the base station,
a reinitialization step of reinitializing the terminal.

2. A method for the authorization of the subscription of a terminal to a base station, comprising:
an initialization step of enabling the base station to go into subscription mode in order to authorize a base station to register with the base station,
a first reception step of receiving a message sent by the terminal and containing an identifier of the terminal,
a second reception step of receiving messages conveying coded information,
a verification step of verifying whether said coded information corresponds to an authorized terminal,
a sending step of sending a message conveying subscription acceptance information for informing the terminal that the subscription is authorized,
a storage step of storing said identifier of the terminal.

3. A terminal comprising means for implementing a method as claimed in claim 1.

4. A base station comprising means for implementing a method as claimed in claim 2.

5. A computer program containing program code instructions for implementing a method as claimed in claim 1.

6. A computer program containing program code instructions for implementing a method as claimed in claim 2.

7. A signal for conveying a computer program as claimed in claim 5.

8. A signal for conveying a computer program as claimed in claim 6.

9. A system comprising a terminal and a base station as claimed in claims 3 and 4.
